(19) United States
(12) Patent Application Publication
(10) Pub. No.: US 2021/0223202 A1
(43) Pub. Date: Jul. 22, 2021

(54) SENSOR ELEMENT AND GAS SENSOR

(71) Applicant: NGK INSULATORS, LTD., Nagoya (JP)

(72) Inventor: Daichi ICHIKAWA, Nagoya (JP)

(21) Appl. No.: 17/137,459

(22) Filed: Dec. 30, 2020

(30) Foreign Application Priority Data
Jan. 21, 2020 (JP) 2020-007270

(51) Int. Cl. G01N 27/41; G01N 27/407

(52) U.S. Cl. CPC G01N 27/41; G01N 27/4076

(57) ABSTRACT

A sensor element according to the present invention includes an element body having a measurement-object gas flow section into which an exhaust gas is introduced, an adjustment pump cell including a measurement-object-gas-side electrode disposed in a portion exposed to the exhaust gas on an outer side of the element body, the adjustment pump cell being configured to adjust an oxygen concentration in an oxygen concentration adjustment chamber included in the measurement-object gas flow section, a measurement electrode disposed in a measurement chamber located downstream of the oxygen concentration adjustment chamber, and a reference electrode into which a reference gas is introduced. The measurement-object-gas-side electrode has an Au/(Pt+Au) ratio (=an area of a portion where Au is exposed/an area of a portion where Au and Pt are exposed) 0.2-0.7, the Au/(Pt+Au) ratio being measured by using XPS.

### CROSS-REFERENCE TO RELATED APPLICATION

The present application claims priority from Japanese Patent Application No. 2020-007270, filed on Jan. 21, 2020, the entire contents of which are incorporated herein by reference.

### BACKGROUND OF THE INVENTION

### 1. Field of the Invention

The present invention relates to a sensor element and a gas sensor.

### 2. Description of the Related Art

Gas sensors are known in the art for detecting a specific gas concentration such as a NOx concentration in a measurement-object gas such as an exhaust gas of an automobile. For example, PTL 1 describes a gas sensor. The gas sensor includes a layered body of a plurality of oxygen-ion-conductive solid electrolyte layers, and electrodes disposed on the solid electrolyte layers. When the gas sensor detects the concentration of NOx, first, pumping-out or pumping-in of oxygen is performed between a measurement-object gas flow section within a sensor element and the outside of the sensor element to adjust the oxygen concentration in the measurement-object gas flow section. Then, NOx in the measurement-object gas after the adjustment of the oxygen concentration is reduced, and the concentration of NOx in the measurement-object gas is detected on the basis of the current flowing through an electrode (measurement electrode) within the sensor element in accordance with the oxygen concentration after the reduction.

### CITATION LIST

### Patent Literature

PTL 1: JP 2014-190940 A

### SUMMARY OF THE INVENTION

Not so many studies have been made on the use of an exhaust gas, which is produced when a spark ignition internal combustion engine burns fuel in the vicinity of the stoichiometric air-fuel ratio, as the measurement-object gas. As a result of the measurement of the concentration of a specific oxide gas contained in an exhaust gas produced when fuel is burned in the vicinity of the stoichiometric air-fuel ratio in a spark ignition internal combustion engine, the inventors of the present invention have found a decrease in measurement accuracy.

The present invention has been made to address the problem described above, and a main object thereof is to accurately measure the concentration of a specific oxide gas contained in an exhaust gas of a spark ignition internal combustion engine.

A sensor element according to the present invention is a sensor element to be used for detecting a concentration of a specific oxide gas contained in an exhaust gas of a spark ignition internal combustion engine as a measurement-object gas, the sensor element including:

an element body including an oxygen-ion-conductive solid electrolyte layer and having provided therein a measurement-object gas flow section into which the exhaust gas is introduced and through which the exhaust gas is caused to flow;

an adjustment pump cell including a measurement-object-gas-side electrode disposed in a portion exposed to the exhaust gas on an outer side of the element body, the adjustment pump cell being configured to adjust an oxygen concentration in an oxygen concentration adjustment chamber included in the measurement-object gas flow section;

a measurement electrode disposed in a measurement chamber located downstream of the oxygen concentration adjustment chamber included in the measurement-object gas flow section; and

a reference electrode which is disposed in the element body and into which a reference gas used as a reference to detect the concentration of the specific oxide gas in the exhaust gas is introduced, wherein

the measurement-object-gas-side electrode contains Pt and Au and has an Au/(Pt+Au) ratio (=an area of a portion where Au is exposed/an area of a portion where Au and Pt are exposed) greater than or equal to 0.2 and less than or equal to 0.7, the Au/(Pt+Au) ratio being measured by using X-ray photoelectron spectroscopy (XPS).

The sensor element can be used to detect the concentration of a specific oxide gas in, for example, an exhaust gas of a spark ignition internal combustion engine in the following way. First, the adjustment pump cell is activated to adjust the oxygen concentration in the exhaust gas, which is introduced into the measurement-object gas flow section, in the oxygen concentration adjustment chamber. Thus, the adjusted exhaust gas reaches the measurement chamber. Then, on the basis of the measurement voltage between the reference electrode and the measurement electrode, a detected value corresponding to oxygen derived from the specific oxide gas and produced in the measurement chamber (oxygen produced when the specific oxide gas itself is reduced in the measurement chamber) is acquired, and the oxide gas concentration in the exhaust gas is detected on the basis of the acquired detected value. When the oxide gas concentration is detected in the way described above, setting the Au/(Pt+Au) ratio of the measurement-object-gas-side electrode to be greater than or equal to 0.2 and less than or equal to 0.7 can accurately measure the concentration of the specific oxide gas in the exhaust gas produced when fuel is burned in the vicinity of the stoichiometric air-fuel ratio in the spark ignition internal combustion engine. The reasons for this are considered to be as follows. The specific oxide gas in the exhaust gas produced when the spark ignition internal combustion engine burns fuel in the vicinity of the stoichiometric air-fuel ratio is usually reduced easily by the catalytic activity of Pt in the measurement-object-gas-side electrode. If such reduction occurs near the measurement-object-gas-side electrode, the exhaust gas in which the concentration of the specific oxide gas is decreased due to the reduction is introduced into the oxygen concentration adjustment chamber, the amount of oxygen derived from the specific oxide gas and produced in the measurement chamber is decreased, and the measurement accuracy of the concentration of the specific oxide gas is considered to be decreased. In the sensor element according to the present invention, in contrast, since the Au/(Pt+Au) ratio of the measurement-object-gas-side electrode is greater than or equal to 0.2, the catalytic activity of Pt is suppressed by the presence of Au. Accordingly, the reduction of the specific oxide gas contained in the exhaust gas produced when fuel is burned in the vicinity of the stoichiometric air-fuel ratio in the spark ignition internal combustion engine is suppressed near the measurement-object-gas-side electrode, and the decrease in the detection accuracy of the concentration of the specific oxide gas is considered to be suppressed. An excessively large Au/(Pt+Au) ratio of the measurement-object-gas-side electrode may decrease the pumping capacity of the adjustment pump cell, making it difficult to appropriately adjust the oxygen concentration in the oxygen concentration adjustment chamber or making it necessary to apply a high voltage to the adjustment pump cell to increase the pumping capacity. In the sensor element according to the present invention, in contrast, since the Au/(Pt+Au) ratio of the measurement-object-gas-side electrode is less than or equal to 0.7, the decrease in the pumping capacity of the adjustment pump cell can be suppressed. From the above, according to the sensor element according to the present invention, it is possible to accurately measure the concentration of a specific oxide gas in the exhaust gas of a spark ignition internal combustion engine.

In the sensor element according to the present invention, the Au/(Pt+Au) ratio may have a lower limit of 0.35. This can sufficiently suppress the catalytic activity of Pt in the measurement-object-gas-side electrode, sufficiently suppress the reduction of the specific oxide gas, and sufficiently suppress the decrease in the detection accuracy of the concentration of the specific oxide gas.

In the sensor element according to the present invention, the Au/(Pt+Au) ratio may have an upper limit of 0.5. This can sufficiently suppress the decrease in the pumping capacity of the adjustment pump cell.

In the sensor element according to the present invention, the Au/(Pt+Au) ratio may be greater than or equal to 0.35 and less than or equal to 0.5. This can sufficiently suppress the decrease in the pumping capacity of the adjustment pump cell while sufficiently suppressing the decrease in the detection accuracy of the concentration of the specific oxide gas.

In the sensor element according to the present invention, the spark ignition internal combustion engine may be a gasoline engine or a natural gas engine. Since a gasoline engine or a natural gas engine burns fuel in the vicinity of the stoichiometric air-fuel ratio and emits an exhaust gas, it is meaningful to use the sensor element according to the present invention.

In the sensor element according to the present invention, the specific oxide gas may be NOx.

A gas sensor according to the present invention includes:

the sensor element according to the present invention having any of the configurations described above;

an adjustment pump cell control unit that activates the adjustment pump cell so that the oxygen concentration in the oxygen concentration adjustment chamber becomes a target concentration;

a measurement voltage detection unit that detects a measurement voltage between the reference electrode and the measurement electrode; and

a specific-gas-concentration detection unit that acquires a detected value corresponding to oxygen derived from the oxide gas and produced in the measurement chamber on the basis of the measurement voltage and detects the concentration of the oxide gas in the exhaust gas on the basis of the detected value.

The gas sensor includes the sensor element having any of the configurations described above. Accordingly, the gas sensor achieves an advantage similar to that of the sensor element according to the present invention described above, for example, the advantage of accurately measuring the concentration of a specific oxide gas in the exhaust gas of a spark ignition internal combustion engine.

### BRIEF DESCRIPTION OF THE DRAWINGS

FIG. 1 is a schematic sectional view schematically illustrating an example configuration of a gas sensor 100.

FIG. 2 is a block diagram illustrating an electrical connection relationship between a control device 90 and each cell.

FIG. 3 is a schematic sectional view of a sensor element 201.

FIG. 4 is a schematic sectional view of a sensor element 301.

FIG. 5 is a graph illustrating relationships between the A/F of a measurement-object gas and Ip2 relative sensitivity in Experimental Examples 1 to 5.

### DETAILED DESCRIPTION OF THE INVENTION

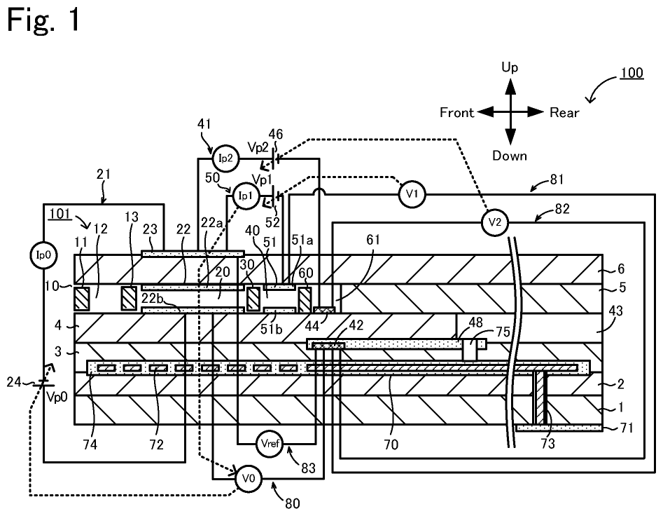

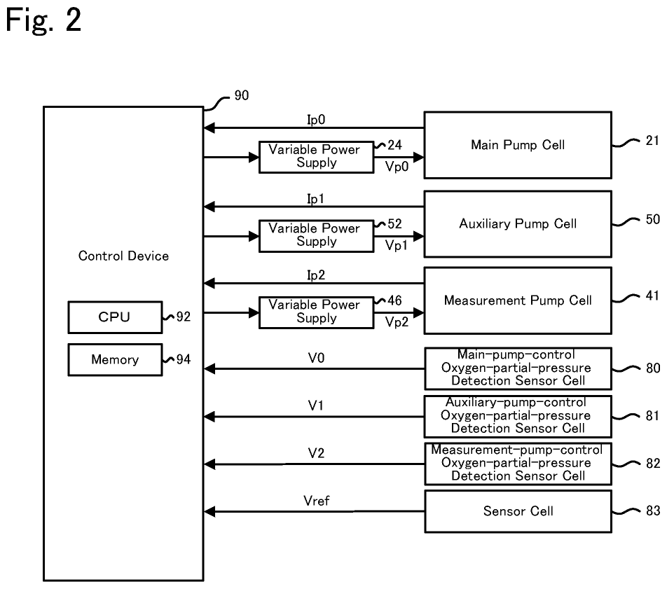

An embodiment of the present invention will now be described with reference to the drawings. FIG. 1 is a schematic sectional view schematically illustrating an example configuration of a gas sensor 100 according to an embodiment of the present invention. FIG. 2 is a block diagram illustrating an electrical connection relationship between a control device 90 and each cell. In this embodiment, the up-down direction and the front-rear direction are as illustrated in FIG. 1, and the farther side of FIG. 1 is referred to as the left side and the closer side of FIG. 1 is referred to as the right side.

The gas sensor 100 is attached to, for example, a pipe such as an exhaust gas pipe of a gasoline engine that is a spark ignition internal combustion engine. The gas sensor 100 detects the concentration of a specific oxide gas (here, NOx) in the exhaust gas of the gasoline engine. The gas sensor 100 includes a sensor element 101 having a long rectangular parallelepiped shape, cells 21, 41, 50, and 80 to 83 included in the sensor element 101, variable power supplies 24, 46, and 52, and the control device 90 that controls the overall operation of the gas sensor 100.

The sensor element 101 is an element including a layered body having six layers, each of which is formed of an oxygen-ion-conductive solid electrolyte layer such as a zirconia (ZrO₂) layer. The six layers include a first substrate layer 1, a second substrate layer 2, a third substrate layer 3, a first solid electrolyte layer 4, a spacer layer 5, and a second solid electrolyte layer 6 and are stacked in the stated order from bottom to top in FIG. 1. The solid electrolyte forming the six layers is dense and gas-tight. The sensor element 101 is manufactured by, for example, after performing predetermined processing and circuit pattern printing on ceramic green sheets, each corresponding to one of the layers, stacking the ceramic green sheets, firing the stacked ceramic green sheets, and combining the fired ceramic green sheets together to form a single unit.

A gas inlet 10, a first diffusion control section 11, a buffer space 12, a second diffusion control section 13, a first internal cavity 20, a third diffusion control section 30, a second internal cavity 40, a fourth diffusion control section 60, and a third internal cavity 61 are formed adjacent to one another in such a manner as to communicate in the stated order on the leading end side of the sensor element 101 (on the left-end side in FIG. 1) between a lower surface of the second solid electrolyte layer 6 and an upper surface of the first solid electrolyte layer 4.

The gas inlet 10, the buffer space 12, the first internal cavity 20, the second internal cavity 40, and the third internal cavity 61 form an internal space of the sensor element 101, which is formed by hollowing a portion of the spacer layer 5, with the top thereof defined by the lower surface of the second solid electrolyte layer 6, the bottom thereof defined by the upper surface of the first solid electrolyte layer 4, and a side thereof defined by a side surface of the spacer layer 5.

The first diffusion control section 11, the second diffusion control section 13, and the third diffusion control section 30 are each disposed as two horizontally long slits (whose openings have a longitudinal direction along a direction perpendicular to the drawing). The fourth diffusion control section 60 is disposed as a single horizontally long slit (whose opening has a longitudinal direction along a direction perpendicular to the drawing), which is formed as a gap from the lower surface of the second solid electrolyte layer 6. Note that the portion from the gas inlet 10 up to the third internal cavity 61 is also referred to as a measurement-object gas flow section.

At a position farther away from the leading end side of the sensor element 101 than the measurement-object gas flow section, a reference-gas introduction space 43 is disposed between an upper surface of the third substrate layer 3 and a lower surface of the spacer layer 5 in such a manner that a side portion of the reference-gas introduction space 43 is defined by a side surface of the first solid electrolyte layer 4. For example, atmospheric air is introduced into the reference-gas introduction space 43 as a reference gas for measuring the NOx concentration.

An atmospheric-air introduction layer 48 is a layer composed of porous ceramics, and the reference gas is introduced into the atmospheric-air introduction layer 48 through the reference-gas introduction space 43. The atmospheric-air introduction layer 48 is formed so as to cover a reference electrode 42.

The reference electrode 42 is an electrode formed so as to be held between the upper surface of the third substrate layer 3 and the first solid electrolyte layer 4, and is surrounded by the atmospheric-air introduction layer 48 connected to the reference-gas introduction space 43, as described above. As described below, the reference electrode 42 can be used to measure the oxygen concentrations (oxygen partial pressures) in the first internal cavity 20, the second internal cavity 40, and the third internal cavity 61. The reference electrode 42 is formed as a porous cermet electrode (e.g., a cermet electrode composed of Pt and ZrO₂).

In the measurement-object gas flow section, the gas inlet 10 is a portion open to an external space, and the measurement-object gas is taken into the sensor element 101 from the external space through the gas inlet 10. The first diffusion control section 11 is a portion that applies a predetermined diffusion resistance to the measurement-object gas taken through the gas inlet 10. The buffer space 12 is a space provided to guide the measurement-object gas introduced through the first diffusion control section 11 to the second diffusion control section 13. The second diffusion control section 13 is a portion that applies a predetermined diffusion resistance to the measurement-object gas to be introduced into the first internal cavity 20 from the buffer space 12. When the measurement-object gas is introduced into the first internal cavity 20 from outside the sensor element 101, the measurement-object gas, which is rapidly taken into the sensor element 101 through the gas inlet 10 due to changes in the pressure of the measurement-object gas in the external space (pulsations in exhaust pressure when the measurement-object gas is an exhaust gas of an automobile), is not directly introduced into the first internal cavity 20, but is introduced into the first internal cavity 20 after the changes in the pressure of the measurement-object gas are compensated for through the first diffusion control section 11, the buffer space 12, and the second diffusion control section 13. Consequently, the changes in the pressure of the measurement-object gas to be introduced into the first internal cavity 20 are almost negligible. The first internal cavity 20 is provided as a space for adjusting the oxygen partial pressure in the measurement-object gas introduced through the second diffusion control section 13. The oxygen partial pressure is adjusted by the operation of the main pump cell 21.

The main pump cell 21 is an electrochemical pump cell including an inner pump electrode 22 having a ceiling electrode portion 22a disposed over substantially an entire lower surface of a portion of the second solid electrolyte layer 6 facing the first internal cavity 20, an outer pump electrode 23 disposed in a region on an upper surface of the second solid electrolyte layer 6 corresponding to the ceiling electrode portion 22a in such a manner that the outer pump electrode 23 is exposed to the external space, and a portion of the second solid electrolyte layer 6 that is held between the electrodes 22 and 23.

The inner pump electrode 22 is formed across the upper and lower solid electrolyte layers defining the first internal cavity 20 (i.e., the second solid electrolyte layer 6 and the first solid electrolyte layer 4), and the spacer layer 5 forming the sidewalls. Specifically, the ceiling electrode portion 22a is formed on the lower surface of the second solid electrolyte layer 6, which forms a ceiling surface of the first internal cavity 20. A bottom electrode portion 22b is formed on the upper surface of the first solid electrolyte layer 4, which forms a bottom surface of the first internal cavity 20. Side electrode portions (not illustrated) are formed on sidewall surfaces (inner surfaces) of the spacer layer 5, which form both sidewall portions of the first internal cavity 20, so as to connect the ceiling electrode portion 22a and the bottom electrode portion 22b to each other. The inner pump electrode 22 is thus disposed to have a tunnel structure in the portion where the side electrode portions are disposed.

The inner pump electrode 22 is formed as a porous cermet electrode (e.g., a cermet electrode composed of Pt and ZrO₂). The inner pump electrode 22, which comes into contact with the measurement-object gas, is formed of a material having lowered reduction ability for the NOx component in the measurement-object gas.

The outer pump electrode 23 is an electrode containing Pt and Au. More specifically, the outer pump electrode 23 is an electrode composed of a cermet of Pt and Au as noble metals and oxide having oxygen ion conductivity (here, ZrO₂). The outer pump electrode 23 has an Au/(Pt+Au) ratio (=the area of a portion where Au is exposed/the area of a portion where Pt and Au are exposed) greater than or equal to 0.2 and less than or equal to 0.7. The Au/(Pt+Au) ratio is measured by using X-ray photoelectron spectroscopy (XPS). A large Au/(Pt+Au) ratio indicates that the area of a Au-covered portion of Pt particles present in the outer pump electrode 23 is large. The outer pump electrode 23 can be formed by using, for example, a conductive paste prepared by mixing a coating powder obtained by coating a Pt powder with Au, a zirconia powder, and a binder. The Au/(Pt+Au) ratio of the outer pump electrode 23 can be adjusted by appropriately changing the weight percentages of Pt and Au in the coating powder. The lower limit of the Au/(Pt+Au) ratio is preferably 0.35, and the upper limit of the Au/(Pt+Au) ratio is preferably 0.5. More preferably, the Au/(Pt+Au) ratio is greater than or equal to 0.35 and less than or equal to 0.5.

In the main pump cell 21, a desired pump voltage Vp0 is applied between the inner pump electrode 22 and the outer pump electrode 23 to cause a pump current Ip0 to flow between the inner pump electrode 22 and the outer pump electrode 23 in the positive direction or the negative direction. Accordingly, the main pump cell 21 is capable of pumping out oxygen to the external space from the first internal cavity 20 or pumping oxygen into the first internal cavity 20 from the external space.

Further, the inner pump electrode 22, the second solid electrolyte layer 6, the spacer layer 5, the first solid electrolyte layer 4, the third substrate layer 3, and the reference electrode 42 form an electrochemical sensor cell, that is, the main-pump-control oxygen-partial-pressure detection sensor cell 80, for detecting the oxygen concentration (oxygen partial pressure) in the atmosphere in the first internal cavity 20.

An electromotive force V0 in the main-pump-control oxygen-partial-pressure detection sensor cell 80 is measured to determine the oxygen concentration (oxygen partial pressure) in the first internal cavity 20. In addition, feedback control is performed on the pump voltage Vp0 of the variable power supply 24 so that the electromotive force V0 becomes a target value to control the pump current Ip0. Accordingly, the oxygen concentration in the first internal cavity 20 can be kept at a predetermined constant value.

The third diffusion control section 30 is a portion that applies a predetermined diffusion resistance to the measurement-object gas in which the oxygen concentration (oxygen partial pressure) is controlled in the first internal cavity 20 by the operation of the main pump cell 21 to guide the measurement-object gas into the second internal cavity 40.

The second internal cavity 40 is provided as a space for, after the adjustment of the oxygen concentration (oxygen partial pressure) in the first internal cavity 20 in advance, further adjusting the oxygen partial pressure in the measurement-object gas introduced through the third diffusion control section 30 by using an auxiliary pump cell 50. Accordingly, the oxygen concentration in the second internal cavity 40 can be kept constant with high accuracy, and thus the gas sensor 100 can accurately measure the NOx concentration.

The auxiliary pump cell 50 is an auxiliary electrochemical pump cell including an auxiliary pump electrode 51 having a ceiling electrode portion 51a disposed over substantially an entire lower surface of a portion of the second solid electrolyte layer 6 facing the second internal cavity 40, the outer pump electrode 23 (or any other suitable electrode on the outer side of the sensor element 101 in place of the outer pump electrode 23), and the second solid electrolyte layer 6.

The auxiliary pump electrode 51 has a tunnel structure similar to that of the inner pump electrode 22 disposed in the first internal cavity 20 described above, and is disposed in the second internal cavity 40. That is, the ceiling electrode portion 51a is formed on the second solid electrolyte layer 6, which forms a ceiling surface of the second internal cavity 40. A bottom electrode portion 51b is formed on the first solid electrolyte layer 4, which forms a bottom surface of the second internal cavity 40. Side electrode portions (not illustrated) connecting the ceiling electrode portion 51a and the bottom electrode portion 51b to each other are formed on both wall surfaces of the spacer layer 5, which form sidewalls of the second internal cavity 40. Thus, the tunnel structure is provided. Like the inner pump electrode 22, the auxiliary pump electrode 51 is also formed of a material having lowered reduction ability for the NOx component in the measurement-object gas.

In the auxiliary pump cell 50, a desired voltage Vp1 is applied between the auxiliary pump electrode 51 and the outer pump electrode 23. Accordingly, the auxiliary pump cell 50 is capable of pumping out oxygen in the atmosphere in the second internal cavity 40 to the external space or pumping oxygen into the second internal cavity 40 from the external space.

Further, the auxiliary pump electrode 51, the reference electrode 42, the second solid electrolyte layer 6, the spacer layer 5, the first solid electrolyte layer 4, and the third substrate layer 3 form an electrochemical sensor cell, that is, the auxiliary-pump-control oxygen-partial-pressure detection sensor cell 81, for controlling the oxygen partial pressure in the atmosphere in the second internal cavity 40.

The auxiliary pump cell 50 performs pumping at the variable power supply 52 whose voltage is controlled on the basis of an electromotive force V1 detected by the auxiliary-pump-control oxygen-partial-pressure detection sensor cell 81. Accordingly, the oxygen partial pressure in the atmosphere in the second internal cavity 40 is controlled to a low partial pressure that does not substantially affect NOx measurement.

Additionally, a pump current Ip1 is used to control the electromotive force of the main-pump-control oxygen-partial-pressure detection sensor cell 80. Specifically, the pump current Ip1 is input as a control signal to the main-pump-control oxygen-partial-pressure detection sensor cell 80, for which the electromotive force V0 is controlled to perform control so that the gradient of the oxygen partial pressure in the measurement-object gas to be introduced into the second internal cavity 40 from the third diffusion control section 30 remains always constant. When the gas sensor 100 is used as a NOx sensor, the oxygen concentration in the second internal cavity 40 is kept at a constant value of about 0.001 ppm by the operation of the main pump cell 21 and the auxiliary pump cell 50.

The fourth diffusion control section 60 is a portion that applies a predetermined diffusion resistance to the measurement-object gas in which the oxygen concentration (oxygen partial pressure) is controlled in the second internal cavity 40 by the operation of the auxiliary pump cell 50 to guide the measurement-object gas into the third internal cavity 61. The fourth diffusion control section 60 serves to limit the amount of NOx flowing into the third internal cavity 61.

The third internal cavity 61 is provided as a space for, after the adjustment of the oxygen concentration (oxygen partial pressure) in the second internal cavity 40 in advance, performing a process on the measurement-object gas introduced through the fourth diffusion control section 60 to measure the nitrogen oxide (NOx) concentration in the measurement-object gas. The measurement of the NOx concentration is mainly performed in the third internal cavity 61 by the operation of a measurement pump cell 41.

The measurement pump cell 41 measures the NOx concentration in the measurement-object gas in the third internal cavity 61. The measurement pump cell 41 is an electrochemical pump cell including a measurement electrode 44 disposed on a portion of the upper surface of the first solid electrolyte layer 4 facing the third internal cavity 61, the outer pump electrode 23, the second solid electrolyte layer 6, the spacer layer 5, and the first solid electrolyte layer 4. The measurement electrode 44 is a porous cermet electrode composed of a material having higher reduction ability for the NOx component in the measurement-object gas than the material of the inner pump electrode 22. The measurement electrode 44 also functions as a NOx reducing catalyst for reducing NOx present in the atmosphere in the third internal cavity 61.

The measurement pump cell 41 is capable of pumping out oxygen, which is produced by decomposition of nitrogen oxide in the atmosphere around the measurement electrode 44, and detecting the amount of produced oxygen as a pump current Ip2.

Further, the first solid electrolyte layer 4, the third substrate layer 3, the measurement electrode 44, and the reference electrode 42 form an electrochemical sensor cell, that is, the measurement-pump-control oxygen-partial-pressure detection sensor cell 82, for detecting the oxygen partial pressure around the measurement electrode 44. The variable power supply 46 is controlled on the basis of an electromotive force V2 detected by the measurement-pump-control oxygen-partial-pressure detection sensor cell 82.

The measurement-object gas guided into the second internal cavity 40, in which the oxygen partial pressure is controlled, passes through the fourth diffusion control section 60 and reaches the measurement electrode 44 in the third internal cavity 61. In the measurement-object gas around the measurement electrode 44, nitrogen oxide is reduced to produce oxygen (2NO→N₂+O₂). The produced oxygen is subjected to pumping by the measurement pump cell 41. In this process, a voltage Vp2 of the variable power supply 46 is controlled so that the electromotive force V2 detected by the measurement-pump-control oxygen-partial-pressure detection sensor cell 82 becomes constant. Since the amount of oxygen produced around the measurement electrode 44 is proportional to the concentration of nitrogen oxide in the measurement-object gas, the nitrogen oxide concentration in the measurement-object gas is calculated using the pump current Ip2 in the measurement pump cell 41.

Further, a combination of the measurement electrode 44, the first solid electrolyte layer 4, the third substrate layer 3, and the reference electrode 42 forms an oxygen partial pressure detection device as an electrochemical sensor cell. Accordingly, an electromotive force corresponding to the difference between the amount of oxygen produced by reducing the NOx component in the atmosphere around the measurement electrode 44 and the amount of oxygen contained in the reference atmospheric air can be detected, and thus the concentration of the NOx component in the measurement-object gas can also be determined.

Further, the second solid electrolyte layer 6, the spacer layer 5, the first solid electrolyte layer 4, the third substrate layer 3, the outer pump electrode 23, and the reference electrode 42 form the electrochemical sensor cell 83. The oxygen partial pressure in the measurement-object gas outside the gas sensor 100 can be detected using an electromotive force Vref obtained by the sensor cell 83.

In the gas sensor 100 having the configuration described above, the main pump cell 21 and the auxiliary pump cell 50 are activated to provide the measurement pump cell 41 with the measurement-object gas in which the oxygen partial pressure is always kept at a constant low value (a value that does not substantially affect NOx measurement). Accordingly, the NOx concentration in the measurement-object gas can be determined on the basis of the pump current Ip2 caused to flow by the measurement pump cell 41 pumping out oxygen produced by reducing NOx approximately in proportion to the concentration of NOx in measurement-object gas.

The sensor element 101 further includes a heater unit 70 that serves to perform temperature adjustment to heat the sensor element 101 and keep the sensor element 101 warm to enhance the oxygen ion conductivity of the solid electrolyte. The heater unit 70 includes a heater connector electrode 71, a heater 72, a through hole 73, a heater insulating layer 74, and a pressure release hole 75.

The heater connector electrode 71 is an electrode formed in contact with a lower surface of the first substrate layer 1. Connecting the heater connector electrode 71 to an external power supply allows power to be fed to the heater unit 70 from the outside.

The heater 72 is an electric resistor formed to be vertically held between the second substrate layer 2 and the third substrate layer 3. The heater 72 is connected to the heater connector electrode 71 via the through hole 73. The heater 72 generates heat in response to power fed thereto from the outside through the heater connector electrode 71 to heat the solid electrolyte forming the sensor element 101 and keep the solid electrolyte warm.

The heater 72 is embedded across an entire area from the first internal cavity 20 to the third internal cavity 61 and is capable of adjusting the temperature of the entire sensor element 101 to a temperature at which the solid electrolyte is active.

The heater insulating layer 74 is an insulating layer formed of an insulating material such as alumina on an upper and lower surfaces of the heater 72. The heater insulating layer 74 is formed to provide electrical insulation between the second substrate layer 2 and the heater 72 and electrical insulation between the third substrate layer 3 and the heater 72.

The pressure release hole 75 is a portion provided so as to extend through the third substrate layer 3 and the atmospheric-air introduction layer 48 and communicate with the reference-gas introduction space 43. The pressure release hole 75 is formed to mitigate an increase in internal pressure caused by a temperature rise in the heater insulating layer 74.

The control device 90 is a microprocessor including a CPU 92, a memory 94, and so on. The control device 90 receives the electromotive force V0 detected by the main-pump-control oxygen-partial-pressure detection sensor cell 80, the electromotive force V1 detected by the auxiliary-pump-control oxygen-partial-pressure detection sensor cell 81, the electromotive force V2 detected by the measurement-pump-control oxygen-partial-pressure detection sensor cell 82, the electromotive force Vref detected by the sensor cell 83, the pump current Ip0 detected by the main pump cell 21, the pump current Ip1 detected by the auxiliary pump cell 50, and the pump current Ip2 detected by the measurement pump cell 41. The control device 90 outputs a control signal to the variable power supplies 24, 46, and 52 and controls the main pump cell 21, the measurement pump cell 41, and the auxiliary pump cell 50.

The control device 90 performs feedback control of the pump voltage Vp0 of the variable power supply 24 so that the electromotive force V0 becomes a target value (referred to as a target value V0*) (i.e., the oxygen concentration in the first internal cavity 20 becomes a target concentration). Accordingly, the pump current Ip0 changes in accordance with the oxygen concentration in the measurement-object gas and thus in accordance with the air-fuel ratio (A/F) of the measurement-object gas and the air excess coefficient λ (=the amount of air supplied to the internal combustion engine/the theoretically required minimum amount of air).

Further, the control device 90 performs feedback control of the voltage Vp1 of the variable power supply 52 so that the electromotive force V1 becomes a constant value (referred to as a target value V1*) (i.e., the oxygen concentration in the second internal cavity 40 becomes a predetermined low oxygen concentration that does not substantially affect NOx measurement). Additionally, the control device 90 sets (performs feedback control of) the target value V0* of the electromotive force V0 on the basis of the pump current Ip1 so that the pump current Ip1 caused to flow by the voltage Vp1 becomes a constant value (referred to as a target value Ip1*). Accordingly, the gradient of the oxygen partial pressure in the measurement-object gas to be introduced into the second internal cavity 40 from the third diffusion control section 30 remains always constant. In addition, the oxygen partial pressure in the atmosphere in the second internal cavity 40 is controlled to a low partial pressure that does not substantially affect NOx measurement. The target value V0* is set to a value such that the oxygen concentration in the first internal cavity 20 becomes a low oxygen concentration higher than 0%.

The control device 90 further performs feedback control of the voltage Vp2 of the variable power supply 46 so that the electromotive force V2 becomes a constant value (referred to as a target value V2*) (i.e., the oxygen concentration in the third internal cavity 61 becomes a predetermined low concentration). Accordingly, oxygen is pumped out from within the third internal cavity 61 so that oxygen produced by reducing NOx in the measurement-object gas in the third internal cavity 61 becomes substantially zero. The control device 90 acquires the pump current Ip2 as a detected value for oxygen derived from a specific oxide gas (here, NOx) and produced in the third internal cavity 61 and calculates the NOx concentration in the measurement-object gas on the basis of the pump current Ip2. The method for pumping out oxygen derived from a specific gas in the measurement-object gas introduced into the sensor element 101 and detecting a specific gas concentration on the basis of the amount of the pumped out oxygen (in this embodiment, on the basis of the pump current Ip2) is referred to as a limiting current method.

The memory 94 stores a relational expression (e.g., a linear function expression), a map, or the like indicating the correspondence between the pump current Ip2 and the NOx concentration. The relational expression or the map may be experimentally determined in advance.

An example use of the gas sensor 100 having the configuration described above will be described hereinafter. The CPU 92 of the control device 90 is assumed to be controlling the pump cells 21, 41, and 50 described above and acquiring the voltages V0, V1, V2, and Vref from the sensor cells 80 to 83 described above, respectively. In this state, when a measurement-object gas is introduced from the gas inlet 10, the measurement-object gas passes through the first diffusion control section 11, the buffer space 12, and the second diffusion control section 13 and reaches the first internal cavity 20. Then, the oxygen concentration in the measurement-object gas is adjusted in the first internal cavity 20 and the second internal cavity 40 by the main pump cell 21 and the auxiliary pump cell 50, and the measurement-object gas after the adjustment reaches the third internal cavity 61. Then, the CPU 92 detects the NOx concentration in the measurement-object gas on the basis of the acquired pump current Ip2 and the correspondence stored in the memory 94.

Accordingly, when the CPU 92 detects the NOx concentration by using the sensor element 101, in this embodiment, as described above, since the Au/(Pt+Au) ratio of the outer pump electrode 23 is greater than or equal to 0.2, the concentration of NOx contained in an exhaust gas produced when fuel is burned in the vicinity of the stoichiometric air-fuel ratio in a gasoline engine can be accurately measured. The reasons for this are considered to be as follows. NOx in an exhaust gas produced when fuel is burned in the vicinity of the stoichiometric air-fuel ratio in a gasoline engine is usually reduced easily by the catalytic activity of Pt in the outer pump electrode 23. If such reduction of NOx occurs near the outer pump electrode 23, the exhaust gas in which the NOx concentration is decreased due to the reduction is introduced into the third internal cavity 61, the amount of oxygen derived from NOx and produced in the third internal cavity 61 is decreased, and the measurement accuracy of the NOx concentration is considered to be decreased. In the sensor element 101 according to this embodiment, in contrast, since the Au/(Pt+Au) ratio of the outer pump electrode 23 is greater than or equal to 0.2, the catalytic activity of Pt is suppressed by the presence of Au. Accordingly, the reduction of NOx contained in an exhaust gas produced when fuel is burned in the vicinity of the stoichiometric air-fuel ratio in the gasoline engine is suppressed near the outer pump electrode 23, and the decrease in the detection accuracy of the NOx concentration is considered to be suppressed.

The larger the Au/(Pt+Au) ratio of the outer pump electrode 23 is, the more the reduction of NOx in the outer pump electrode 23 described above can be suppressed. In this respect, the Au/(Pt+Au) ratio of the outer pump electrode 23 is preferably greater than or equal to 0.2, and more preferably greater than or equal to 0.35.

An excessively large Au/(Pt+Au) ratio of the outer pump electrode 23 may decrease the pumping capacity of the main pump cell 21, making it difficult to appropriately adjust the oxygen concentration in the first internal cavity 20 or making it necessary to apply a high pump voltage Vp0 to increase the pumping capacity. In this respect, the Au/(Pt+Au) ratio of the outer pump electrode 23 is preferably less than or equal to 0.7, and more preferably less than or equal to 0.5.

The correspondence between the constituent elements of this embodiment and the constituent elements according to the present invention will now be clarified. A layered body according to this embodiment having six layers including the first substrate layer 1, the second substrate layer 2, the third substrate layer 3, the first solid electrolyte layer 4, the spacer layer 5, and the second solid electrolyte layer 6, which are stacked in the stated order, corresponds to an element body according to the present invention, the second solid electrolyte layer 6 corresponds to a solid electrolyte layer, the first internal cavity 20 corresponds to an oxygen concentration adjustment chamber, the outer pump electrode 23 corresponds to a measurement-object-gas-side electrode, the main pump cell 21 corresponds to an adjustment pump cell, the third internal cavity 61 corresponds to a measurement chamber, the measurement electrode 44 corresponds to a measurement electrode, and the reference electrode 42 corresponds to a reference electrode. Further, the CPU 92 and the variable power supply 24 correspond to an adjustment pump cell control unit, the CPU 92 corresponds to a specific-gas-concentration detection unit, the measurement-pump-control oxygen-partial-pressure detection sensor cell 82 corresponds to a measurement voltage detection unit, and the pump current Ip2 corresponds to a detected value.

According to the gas sensor 100 according to this embodiment described above, since the Au/(Pt+Au) ratio of the outer pump electrode 23 is greater than or equal to 0.2, the catalytic activity of Pt is suppressed by the presence of Au. Accordingly, the reduction of NOx contained in an exhaust gas produced when fuel is burned in the vicinity of the stoichiometric air-fuel ratio in the gasoline engine is suppressed near the outer pump electrode 23, and the decrease in the detection accuracy of the NOx concentration is suppressed. In addition, since the Au/(Pt+Au) ratio of the outer pump electrode 23 is less than or equal to 0.7, the decrease in the pumping capacity of the main pump cell 21 can be suppressed.

Furthermore, setting the lower limit of the Au/(Pt+Au) ratio of the outer pump electrode 23 to 0.35 can sufficiently suppress the catalytic activity of Pt in the outer pump electrode 23, sufficiently suppress the reduction of NOx, and sufficiently suppress the decrease in the detection accuracy of the NOx concentration.

In addition, setting the upper limit of the Au/(Pt+Au) ratio of the outer pump electrode 23 to 0.5 can sufficiently suppress the decrease in the pumping capacity of the adjustment pump cell.

Moreover, setting the Au/(Pt+Au) ratio to be greater than or equal to 0.35 and less than or equal to 0.5 can sufficiently suppress the decrease in the pumping capacity of the adjustment pump cell while sufficiently suppressing the decrease in the detection accuracy of the concentration of the specific oxide gas.

Since a gasoline engine burns fuel in the vicinity of the stoichiometric air-fuel ratio and emits an exhaust gas, it is meaningful to use the gas sensor 100.

It goes without saying that the present invention is not limited to the embodiment described above and may be implemented in various forms within the technical scope of the present invention.

For example, but not limitation, in the embodiment described above, the gas sensor 100 detects the NOx concentration as the concentration of a specific oxide gas. The gas sensor 100 may detect any other oxide concentration as the concentration of a specific oxide gas. In the case of the measurement of the concentration of a specific oxide gas, as in the embodiment described above, oxygen is produced when the specific oxide gas itself is reduced in the third internal cavity 61, and thus the CPU 92 acquires a detected value corresponding to the oxygen, thereby detecting the concentration of the specific oxide gas.

While the embodiment described above exemplifies an application of the present invention to, as a spark ignition internal combustion engine, an internal combustion engine that uses gasoline as fuel, the present invention may be applied to an internal combustion engine that uses natural gas as fuel or an internal combustion engine that uses ethanol-added gasoline as fuel.

In the embodiment described above, the element body of the sensor element 101 is a layered body having a plurality of solid electrolyte layers (the layers 1 to 6), although this is not intended to be limiting. The element body of the sensor element 101 may include at least one oxygen-ion-conductive solid electrolyte layer and may have provided therein a measurement-object gas flow section. For example, in FIG. 1, the layers 1 to 5 other than the second solid electrolyte layer 6 may be structural layers composed of a material other than that of a solid electrolyte layer (e.g., layers composed of alumina). In this case, the electrodes of the sensor element 101 may be disposed in the second solid electrolyte layer 6. For example, the measurement electrode 44 illustrated in FIG. 1 may be disposed on the lower surface of the second solid electrolyte layer 6. The reference-gas introduction space 43 may be disposed in the spacer layer 5 in place of the first solid electrolyte layer 4, the atmospheric-air introduction layer 48 may be disposed between the second solid electrolyte layer 6 and the spacer layer 5, instead of between the first solid electrolyte layer 4 and the third substrate layer 3, and the reference electrode 42 may be disposed behind the third internal cavity 61 and on the lower surface of the second solid electrolyte layer 6.

In the embodiment described above, the control device 90 sets (performs feedback control of) the target value V0* of the electromotive force V0 on the basis of the pump current Ip1 so that the pump current Ip1 becomes the target value Ip1*, and performs feedback control of the pump voltage Vp0 so that the electromotive force V0 becomes the target value V0*. However, other control may be performed. For example, the control device 90 may perform feedback control of the pump voltage Vp0 on the basis of the pump current Ip1 so that the pump current Ip1 becomes the target value Ip1*. That is, the control device 90 may omit the acquisition of the electromotive force V0 from the main-pump-control oxygen-partial-pressure detection sensor cell 80 and the setting of the target value V0*, and may directly control the pump voltage Vp0 (and therefore control the pump current Ip0) on the basis of the pump current Ip1.

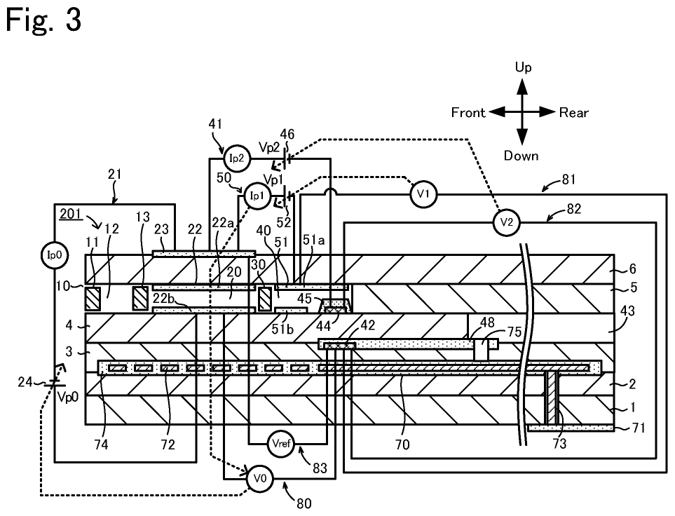

In the embodiment described above, the sensor element 101 of the gas sensor 100 includes the first internal cavity 20, the second internal cavity 40, and the third internal cavity 61, although this is not intended to be limiting. For example, as in a sensor element 201 illustrated in FIG. 3, the third internal cavity 61 may not be included. In the sensor element 201 according to a modification illustrated in FIG. 3, the gas inlet 10, the first diffusion control section 11, the buffer space 12, the second diffusion control section 13, the first internal cavity 20, the third diffusion control section 30, and the second internal cavity 40 are formed adjacent to one another in such a manner as to communicate in the stated order between the lower surface of the second solid electrolyte layer 6 and the upper surface of the first solid electrolyte layer 4. The measurement electrode 44 is disposed on the upper surface of the first solid electrolyte layer 4 within the second internal cavity 40. The measurement electrode 44 is covered with a fourth diffusion control section 45. The fourth diffusion control section 45 is a film formed of a porous ceramic body of alumina (Al₂O₃) or the like. Like the fourth diffusion control section 60 according to the embodiment described above, the fourth diffusion control section 45 serves to limit the amount of NOx flowing into the measurement electrode 44. The fourth diffusion control section 45 also functions as a protective film of the measurement electrode 44. The ceiling electrode portion 51a of the auxiliary pump electrode 51 is formed to extend up to the position immediately above the measurement electrode 44. The sensor element 201 having the configuration described above can also detect the NOx concentration on the basis of the pump current Ip2, for example, in a way similar to that in the embodiment described above. In this case, a portion around the measurement electrode 44 functions as a measurement chamber.

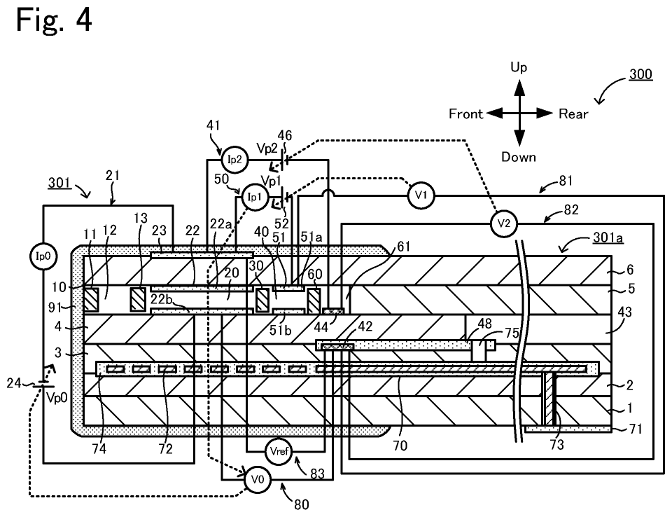

In the embodiment described above, nothing is disposed on the outer periphery of the element body of the sensor element 101 of the gas sensor 100, although this is not intended to be limiting. For example, as in a sensor element 301 illustrated in FIG. 4, a porous protective layer 91 may be disposed so as to cover the leading end side of an element body 301a. As illustrated in FIG. 4, the sensor element 301 is provided with the porous protective layer 91 so as to cover not only a front surface of the element body 301a but also upper, lower, left, and right side surfaces of a front portion of the element body 301a. Accordingly, the gas inlet 10 and the outer pump electrode 23 are covered with the porous protective layer 91. The porous protective layer 91 serves to, for example, prevent the element body 301a from cracking due to adhesion of moisture or the like in the measurement-object gas. The porous protective layer 91 is a porous body and preferably contains ceramic particles as constituent particles, and more preferably contains particles of at least one of alumina, zirconia, spinel, cordierite, titania, and magnesia. Further, the porous protective layer 91 is formed by attaching particles of alumina or the like to the surface of the element body 301a by plasma spraying. In the sensor element 301 having the configuration described above, the outer pump electrode 23 needs to be exposed from the porous protective layer 91 to measure the Au/(Pt+Au) ratio of the outer pump electrode 23. To expose the outer pump electrode 23, an external force is applied to the porous protective layer 91, a crack is developed due to the remaining internal stress, and only the porous protective layer 91 is broken to remove the porous protective layer 91 from an upper surface of the outer pump electrode 23. Then, the measurement is performed on the upper surface of the outer pump electrode 23. Alternatively, the outer pump electrode 23 is divided in the up-down direction, the fracture cross section of the outer pump electrode 23 is exposed, and the measurement is performed on the fracture cross section of the outer pump electrode 23. In this case, the Au/(Pt+Au) ratio in the outer pump electrode 23 is measured. Since the Au particles and the Pt particles on the fracture cross section are considered to be in the same state as that on the upper surface of the outer pump electrode 23, the Au/(Pt+Au) ratio can be measured in the same way as that on the upper surface of the outer pump electrode 23.

### EXAMPLES

The following describes examples indicating specific examples of manufacturing a sensor element. Experimental Examples 1 to 4 correspond to examples of the present invention, and Experimental Example 5 corresponds to a comparative example. Note that the present invention is not limited to the following examples.

[Manufacture of Sensor Element in Experimental Examples 1 to 5]

The sensor element 101 illustrated in FIG. 1 was manufactured in Experimental Examples 1 to 5. Experimental Examples 1 to 5 were the same in manufacturing, except that the values of the Au/(Pt+Au) ratio of the outer pump electrode 23 were different. First, six ceramic green sheets were prepared, which were formed by mixing zirconia particles containing 4 mol % of yttria as a stabilizer, an organic binder, and an organic solvent and molding the mixture by tape casting. A plurality of sheet holes used for positioning at the time of printing or stacking, a plurality of required through holes, and the like were formed in the green sheets in advance. A conductive paste pattern for forming each electrode was printed on each green sheet. Then, the six green sheets were stacked in a predetermined order and pressed by applying predetermined temperature and pressure conditions. An unfired layered body having a size corresponding to that of the sensor element 101 was cut out from the resulting pressed body. The cut unfired layered body was then fired, and the sensor element 101 was obtained. The conductive paste for the outer pump electrode 23 was prepared by mixing a coating powder obtained by coating a Pt powder with Au, a zirconia powder, and a binder. The weight percentages of Pt and Au in the coating powder were appropriately changed to change the Au/(Pt+Au) ratio of the outer pump electrode 23 in Experimental Examples 1 to 5.

[Measurement of Au/(Pt+Au) Ratio]

A plurality of sensor elements 101 of Experimental Example 1 were prepared, and the Au/(Pt+Au) ratios on the upper surfaces of the outer pump electrodes 23 of some (three) of the sensor elements 101 were measured by using X-ray photoelectron spectroscopy (XPS). The Au/(Pt+Au) ratios were calculated from the peak intensities of detected peaks of Au and Pt by using the relative sensitivity factor method. As a relative sensitivity factor, an atomic relative sensitivity factor (ARSF) was used. The average of the measured Au/(Pt+Au) ratios of the three outer pump electrodes 23 was used as the Au/(Pt+Au) ratio of the outer pump electrode 23 of Experimental Example 1. The Au/(Pt+Au) ratio was measured in a similar way for Experimental Examples 2 to 5. Measurement conditions for the Au/(Pt+Au) ratio are as follows.

Measurement apparatus: QuanteraS manufactured by Physical Electronics Inc.;

X-ray source: monochromatic Al (1486.6 eV);

Detection area: 100 μmϕ

Detection depth: about 4 to 5 nm

Spectroscope: electrostatic hemispherical energy analyzer

Extraction angle: 45°

Angle between X-ray and spectroscope: 90°

Detected spectrum (detected peak): Au4f, Pt4f

Measurement results for the Au/(Pt+Au) ratio of the outer pump electrode 23 were 0.21 in Experimental Example 1, 0.35 in Experimental Example 2, 0.49 in Experimental Example 3, 0.68 in Experimental Example 4, and 0 in Experimental Example 5.

[Evaluation Test 1: Evaluation of Measurement Accuracy]

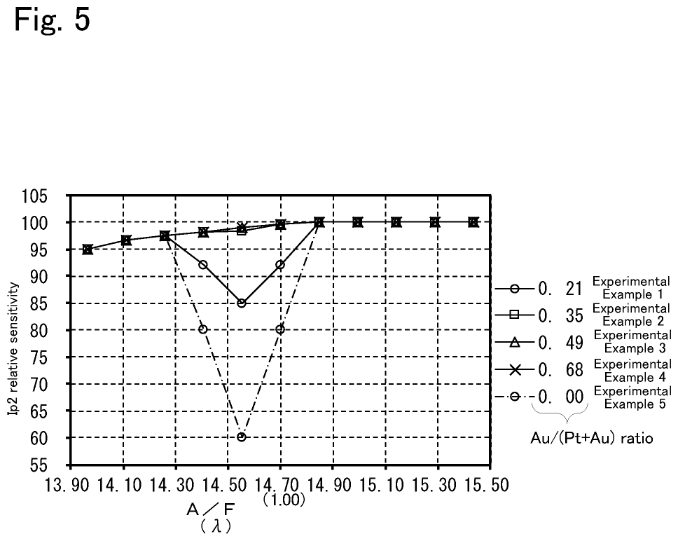

The sensor element 101 of Experimental Example 1 was connected to the control device 90 and the variable power supplies 24, 46, and 52 described above, and the sensor element 101 was driven by the control device 90 in a manner similar to that in the embodiment described above. Then, the pump current Ip2 was measured when the A/F of the measurement-object gas, which had not been introduced into the gas inlet 10 of the sensor element 101, was variously changed. A model gas was used as the measurement-object gas. In the model gas, nitrogen was used as a base gas, 500 ppm NO was used as a specific oxide gas component, and the moisture concentration was set to 3 vol %. Ethylene gas (C₂H₄) was used as a fuel gas, and the A/F of the model gas was variously changed by variously changing the ethylene gas concentration and the oxygen concentration in the model gas. The temperature of the model gas was set to 250° C., and the model gas was caused to flow through a pipe having a diameter of 20 mm at a flow rate of 200 L/min. The measurement of the pump current Ip2 was performed after the flow of the model gas was started and the pump current Ip2 became sufficiently stable. Further, 11 model gases that are different in A/F were used as the measurement-object gas, and, for each A/F, the pump current Ip2 corresponding to the A/F was measured. The A/F was measured using MEXA-760λ manufactured by Horiba, Ltd. Then, the measured pump current Ip2 was relativized using, as a value of 100, the pump current Ip2 obtained when the A/F of the measurement-object gas was 15.27 to derive a value (referred to as Ip2 relative sensitivity). The Ip2 relative sensitivity was also derived for Experimental Examples 2 to 5 by using a similar method. The Au/(Pt+Au) ratio on the upper surface of the outer pump electrode 23 and the Ip2 relative sensitivity corresponding to the A/F of the measurement-object gas for each of Experimental Examples 1 to 5 are shown in Table 1. FIG. 5 is a graph illustrating relationships between the A/F of the measurement-object gas and the Ip2 relative sensitivity in Experimental Examples 1 to 5. The graph indicates that as the Ip2 relative sensitivity changes from 100, the measurement accuracy of the NOx concentration decreases. In Table 1, the air excess coefficient λ (=(A/F)/14.7), which is converted from the A/F, is also shown. Also in FIG. 5, the air excess coefficient λ corresponding to an A/F of 14.7 is also shown in parentheses.

TABLE 1

| | | Experi- | Experi- | Experi- | Experi- | Experi- |
|---|---|---|---|---|---|---|
| | | mental | mental | mental | mental | mental |
| | | Example | Example | Example | Example | Example |
| | | 1 | 2 | 3 | 4 | 5 |
| | | Au/(Pt + Au) ratio | | | | |
| | | 0.21 | 0.35 | 0.49 | 0.68 | 0.00 |
| A/ F | λ | Ip2 relative sensitivity | | | | |
| 13.97 | 0.95 | 95.08 | 95.08 | 95.08 | 95.08 | 95.08 |
| 14.11 | 0.96 | 96.81 | 96.81 | 96.81 | 96.81 | 96.81 |
| 14.26 | 0.97 | 97.56 | 97.56 | 97.56 | 97.56 | 97.56 |
| 14.41 | 0.98 | 92.00 | 98.31 | 98.31 | 98.31 | 80.00 |
| 14.55 | 0.99 | 85.00 | 98.44 | 99.03 | 99.03 | 60.00 |
| 14.70 | 1.00 | 92.00 | 99.63 | 99.63 | 99.63 | 80.00 |
| 14.85 | 1.01 | 100.00 | 100.00 | 100.00 | 100.00 | 100.00 |
| 14.99 | 1.02 | 100.00 | 100.00 | 100.00 | 100.00 | 100.00 |
| 15.14 | 1.03 | 100.00 | 100.00 | 100.00 | 100.00 | 100.00 |
| 15.29 | 1.04 | 100.00 | 100.00 | 100.00 | 100.00 | 100.00 |
| 15.44 | 1.05 | 100.00 | 100.00 | 100.00 | 100.00 | 100.00 |

As indicated in Table 1 and FIG. 5, in Experimental Example5in which the Au/(Pt+Au) ratio of the outer pump electrode 23 was 0, the Ip2 relative sensitivity was decreased by about 40% in the vicinity of the stoichiometric air-fuel ratio (14.41≤A/F≤14.99, 0.98≤λ≤1.02), and the measurement accuracy of the NOx concentration was decreased. In Experimental Example 1, although the Ip2 relative sensitivity was decreased by about 15%, the decrease in the measurement accuracy of the NOx concentration can be suppressed compared with Experimental Example 5. In all of Experimental Examples 2 to 4, in contrast, the Ip2 relative sensitivity was 100 or a value close to 100 in the vicinity of the stoichiometric air-fuel ratio, and no decrease in measurement accuracy was observed.

What is claimed is:

1. A sensor element to be used for detecting a concentration of a specific oxide gas contained in an exhaust gas of a spark ignition internal combustion engine as a measurement-object gas, the sensor element comprising:
an element body including an oxygen-ion-conductive solid electrolyte layer and having provided therein a measurement-object gas flow section into which the exhaust gas is introduced and through which the exhaust gas is caused to flow;
an adjustment pump cell including a measurement-object-gas-side electrode disposed in a portion exposed to the exhaust gas on an outer side of the element body, the adjustment pump cell being configured to adjust an oxygen concentration in an oxygen concentration adjustment chamber included in the measurement-object gas flow section;
a measurement electrode disposed in a measurement chamber located downstream of the oxygen concentration adjustment chamber included in the measurement-object gas flow section; and
a reference electrode which is disposed in the element body and into which a reference gas used as a reference to detect the concentration of the specific oxide gas in the exhaust gas is introduced, wherein
the measurement-object-gas-side electrode contains Pt and Au and has an Au/(Pt+Au) ratio (=an area of a portion where Au is exposed/an area of a portion where Au and Pt are exposed) greater than or equal to 0.2 and less than or equal to 0.7, the Au/(Pt+Au) ratio being measured by using X-ray photoelectron spectroscopy (XPS).

2. The sensor element according to claim 1, wherein
the Au/(Pt+Au) ratio has a lower limit of 0.35.

3. The sensor element according to claim 1, wherein
the Au/(Pt+Au) ratio has an upper limit of 0.5.

4. The sensor element according to claim 1, wherein
the Au/(Pt+Au) ratio is greater than or equal to 0.35 and less than or equal to 0.5.

5. The sensor element according to claim 1, wherein
the spark ignition internal combustion engine is a gasoline engine or a natural gas engine.

6. The sensor element according to claim 1, wherein
the concentration of the specific oxide gas is a NOx concentration.

7. A gas sensor comprising:
the sensor element according to claim 1;
an adjustment pump cell control unit that activates the adjustment pump cell so that the oxygen concentration in the oxygen concentration adjustment chamber becomes a target concentration;
a measurement voltage detection unit that detects a measurement voltage between the reference electrode and the measurement electrode; and
a specific-gas-concentration detection unit that acquires a detected value corresponding to oxygen derived from the oxide gas and produced in the measurement chamber on the basis of the measurement voltage and detects the concentration of the oxide gas in the exhaust gas on the basis of the detected value.
